(19) United States
(12) Patent Application Publication
(10) Pub. No.: US 2009/0119011 A1
(43) Pub. Date: May 7, 2009

(54) Navigation Apparatus

(75) Inventors: Keisuke KONDO, Utsunomiya-shi (JP); Hirofumi Kinoshita, Utsunomiya-shi (JP); Toru Murayama, Utsunomiya-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/264,548

(22) Filed: Nov. 4, 2008

(30) Foreign Application Priority Data
Nov. 7, 2007 (JP) 2007-289442

(51) Int. Cl. G01C 21/26

(52) U.S. Cl. 701/209

(57) ABSTRACT

A navigation apparatus includes: an input operating unit; a map image storage member; a current position detecting member; a destination determination member; a visiting order determination member which determines a visiting order of each of the plurality of destinations in an revisable manner; a display control member which displays on the display member the map image on which the current position of the user and positions of all of the plurality of destinations are displayed; and a route calculation member which calculates a route from the current position by way of all of the plurality of destinations according to the visiting orders.

### BACKGROUND OF THE INVENTION

1. Field of the Invention

The present invention relates to a navigation apparatus.

Priority is claimed on Japanese Patent Application No. 2007-289442, filed Nov. 7, 2007, the contents of which are incorporated herein by reference.

2. Description of Related Art

In the technical field of route guidance display from a departure place to a final destination by way of a plurality of destinations (stopping places), there is known a conventional navigation apparatus which summarize the relative positional relationships of individual stopping points in the whole route from the departure place to the final destination, and displays visiting orders of the individual stopping points (for example, refer to Japanese Unexamined Patent Application, First Publication No. H5-313572).

A navigation apparatus related to the above-described conventional technology shows only summarized relative positional relationships of individual stopping points in the whole route from the departure place to the final destination. Therefore, an operator of the navigation apparatus can not see the actual road maps or consider other routes that may be selected. Thus, problems arise in that it is inconvenient, for example, in a case where the final destination or stopping places are repeatedly changed.

In addition, it is necessary to execute calculation to summarize the relative positional relationships every each time a final destination or a stopping place is added or deleted. Thus, there is a concern that the time necessary to determine the final destination and the stopping places may be excessively lengthened.

The present invention has been made in view of the above situation, an object of which is to provide a navigation apparatus capable of improving the convenience when determining a plurality of destinations, while preventing the excessive lengthening of time for determining a plurality of destinations.

### SUMMARY OF THE INVENTION

The present invention employed the followings:

(1) a navigation apparatus including: an input operating unit which receives instructions of a user; a map image storage member which stores a map image; a display member capable of displaying the map image; a current position detecting member which detects the current position of a user; a destination determination member which determines a plurality of destinations; a visiting order determination member which determines a visiting order of each of the plurality of destinations in an revisable manner; a display control member which displays on the display member the map image on which the current position of the user and positions of all of the plurality of destinations are displayed; and a route calculation member which calculates a route from the current position by way of all of the plurality of destinations according to the visiting orders.

According to the navigation apparatus, when determining or revising visiting orders of a plurality of destinations, the current position and the positions of all the destinations are displayed on a map image. Therefore, an operator can see an actual road map and consider alternative selectable routes. Furthermore, the operation can be improved, even when operations such as addition/deletion of destinations and revision of visiting orders are repeatedly executed.

The navigation apparatus may be constituted as follows:

(2) the route calculation member starts the calculation of the route after displaying the map image on which the current position of the user and the positions of all of the plurality of destinations are displayed.

In this case, it is possible to prevent the calculation of unnecessary routes before the destinations and visiting orders are finalized. As a result, even where operations such as addition/deletion of destinations and revisions in visiting orders are repeatedly executed, it is possible to prevent excessive lengthening of the time necessary for finalizing the destinations and visiting orders.

The navigation apparatus may be constituted as follows:

(3) the route calculation member starts the calculation of the route after a user instruction to execute the calculation through the input operating unit.

The navigation apparatus may be constituted as follows:

(4) the display control member displays the visiting orders corresponding to each of the destinations on the map image.

According to the navigation apparatus, it is possible to further improve the convenience in the operation.

The present invention also employed the followings:

(5) a navigation method including: displaying a map image on a display member; detecting the current position of a user; obtaining a plurality of destinations; determining or revising visiting orders of each of the plurality of destinations; displaying on the display member the map image on which the current position and positions of all the destinations; and calculating a route connecting the current position and all the destinations according to the visiting orders.

The navigation method may be performed as follows:

(6) calculating the route starts is performed after displaying the destinations.

The navigation method may be performed as follows:

(7) calculating the route starts is performed after an instruction of the user to perform the calculation.

The navigation method may be performed as follows:

(8) when displaying the destinations on the map image, the visiting order corresponding to each of the destinations is displayed.

### BRIEF DESCRIPTION OF THE DRAWINGS

FIG. 1 is a block diagram showing a navigation apparatus of one embodiment of the present invention.

FIG. 2 is a drawing showing one example of an arrangement of an input operating unit of the navigation apparatus of the embodiment.

FIG. 3 is a perspective view showing the input operating unit of the navigation apparatus of the embodiment.

FIG. 4 is a sectional view of the input operating unit of the navigation apparatus of the embodiment.

FIG. 5 is a drawing showing an example of a display screen of a display device on the navigation apparatus of the embodiment.

FIG. 6 is a flow chart showing the operation of the navigation apparatus of the embodiment, and in particular, the processing of determining a plurality of destinations and visiting orders of the plural destinations.

### DETAILED DESCRIPTION OF THE INVENTION

Hereinafter, an explanation will be made for one embodiment of the navigation apparatus of the present invention by referring to the attached drawings.

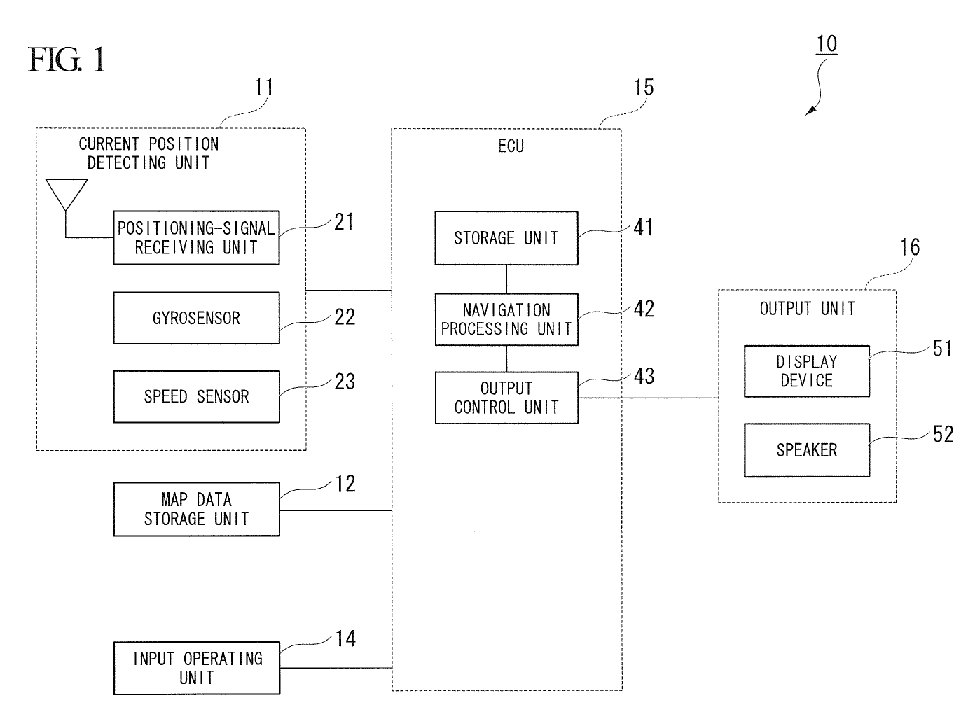

The navigation apparatus 10 of the present embodiment is, for example, as shown in FIG. 1, provided with a current position detecting unit 11, a map data storage unit 12, an input operating unit 14, an ECU 15 and an output unit 16.

The current position detecting unit 11 is provided with: a positioning-signal receiving unit 21 for receiving positioning signals, such as a GPS (Global Positioning System) signal for determining the position of a vehicle by utilizing an artificial satellite, and a DGPS (Differential Global Positioning System) signal for correcting errors in the GPS signal by utilizing any available base station to improve the positioning accuracy; a gyrosensor 22 for detecting the orientation of a vehicle within a horizontal plane, an inclined angle of a vehicle with respect to the perpendicular direction (for example, an inclined angle of axles of a vehicle in the front-back direction with respect to the perpendicular direction, or a yaw angle, which is a rotational angle of the center of gravity of the vehicle about the vertical axis) and a variation amount of the inclined angle (for example, yaw rate); and a speed sensor 23 for detecting the speed of a vehicle (vehicle speed). The current position detecting unit 11 calculates the current position of a vehicle by referring to the thus received positioning signals or conducting the calculation and processing of autonomous navigation based on signals detected for vehicle speed and yaw rate.

The map data storage unit 12 accommodates, for example, map data to be displayed on a display screen 51a of a display device 51 of the output unit 16, and road data made up of information on traffic connection conditions, configurations of roads and others.

The map data is constituted, for example, with geographical data; polygon data corresponding to various types of facilities, city blocks, limnology, or the like; character data covering names of facilities; names of places or the like corresponding to each polygon; and data covering various types of signs.

The road data is constituted, for example, with data covering nodes (in other words, coordinate points for describing the configuration of a road), links which are lines connecting each of the nodes, the length of each link, type, width, crossing angle and configuration of roads.

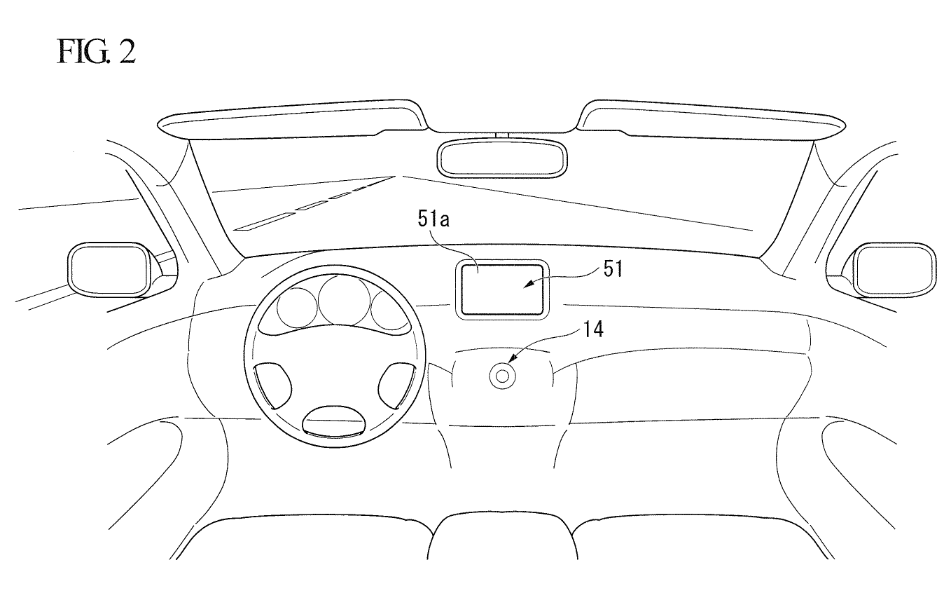

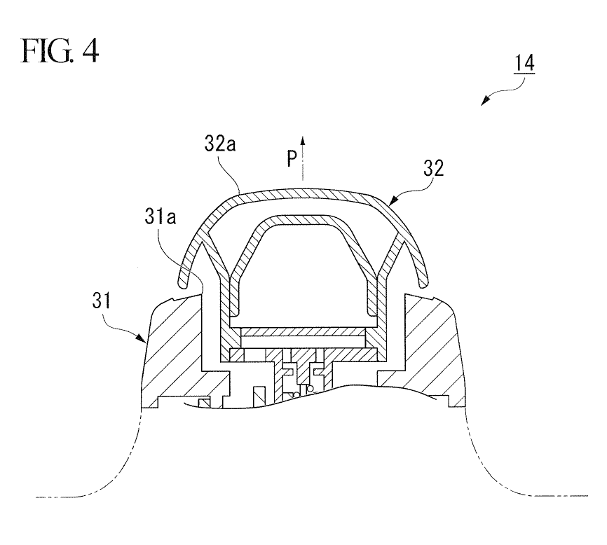

The input operating unit 14 is provided, for example, as shown in FIG. 2 to FIG. 4, with a rotational operation member 31 and a slide operation member 32 projected from an instrument panel at a position deviated downward from the display device 51 of the output unit 16.

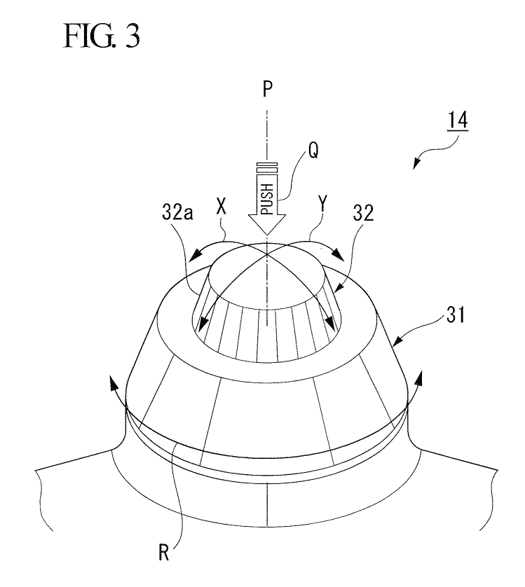

The rotational operation member 31, which is formed in approximately a cylindrical shape, is able to rotate around an axial line P (for example, a direction indicated by the arrow R in FIG. 3).

The slide operation member 32 is formed approximately in a column shape, the outer diameter of which is smaller than the inner diameter of the rotational operation member 31. The slide operation member 32 is arranged inside the rotational operation member 31 so as to be coaxial with the rotational operation member 31. The leading end portion 32a of the slide operation member 32 is arranged so as to project from an opening end 31a of the rotational operation member 31. The slide operation member 32 is able to undergo displacement in the direction of axial line P and any direction orthogonal to the axial line P (for example, directions indicated by the arrows X and Y in FIG. 3).

A home position of the slide operation member 32 is configured in the direction of axial line P and in the direction orthogonal to the axial line P. When there is no input operation from the operator (such as a pressing operation in the direction of axial line P, or a sliding operation in a direction orthogonal to the axial line P), the slide operation member 32 automatically returns to the home position by the function of a return mechanism (not illustrated).

Further, the input operating unit 14 is provided with sensors (not illustrated) such as encoders. One of the sensors detects the rotational angle and rotational speed of the rotational operation member 31. Another sensor detects a displacement in the direction of axial line P and a direction orthogonal to the axial line P of the slide operation member 32. Signals of detection values output from these sensors are input into the ECU 15.

The input operating unit 14 may include, for example, a touch panel type input device.

The ECU 15 is constituted, for example, with a storage unit 41, a navigation processing unit 42 and an output control unit 43.

The storage unit 41 stores, for example, the current position output from the current position detecting unit 11 and also stores, for example, a destination determined by an input operation of the input operating unit 14 of an operator.

The storage unit 41 also selects from a plurality of destinations any one of them, for example, according to an input operation of the input operating unit 14 by an operator, thereby selecting it as a final destination. The storage unit 41 stores destinations other than the final destination as stopping places between the current position and the final destination. The storage unit 41 stores visiting orders determined for each of all the destinations.

The navigation processing unit 42 conducts, for example, map matching with respect to a road data map obtained from the map data storage unit 12 on the basis of the current position output from the current position detecting unit 11. The navigation processing unit 42 executes processing such as route search and route guidance with respect to a destination determined according to an input operation of the input operating unit 14 by an operator. The navigation processing unit 42 outputs instructions for controlling operations of the display device 51 of the output unit 16 and those of the speaker 52.

The output control unit 43 controls the display device 51 of the output unit 16 as well as, for example, the speaker 52 according to control instructions output from the navigation processing unit 42 or an input operation of the input operating unit 14 by an operator.

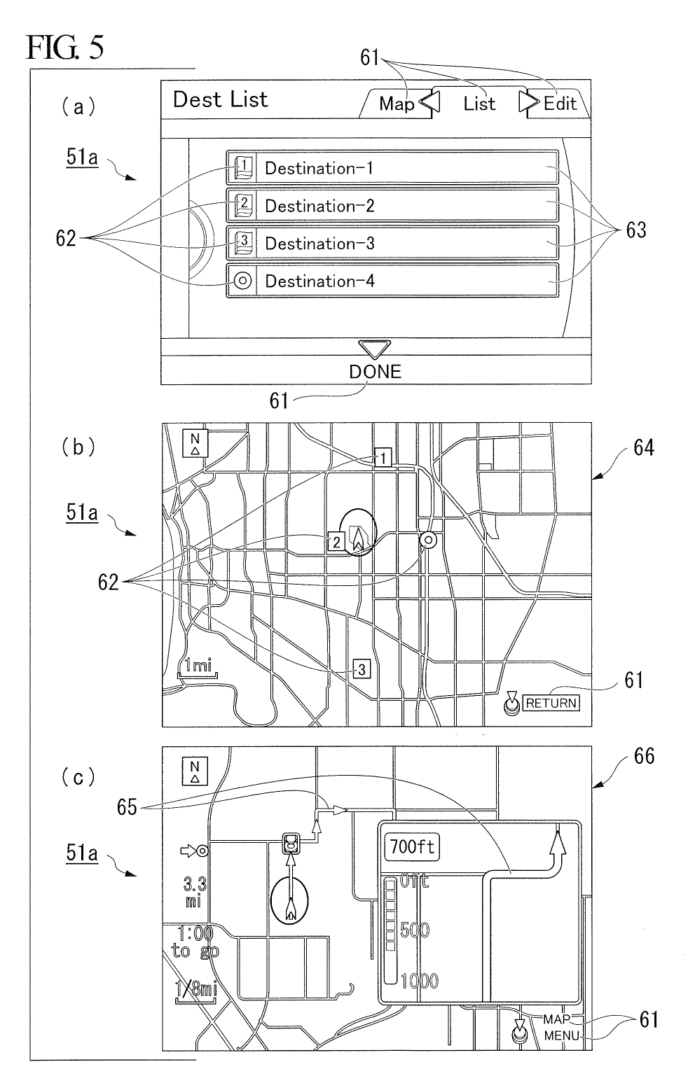

The navigation apparatus 10 of the present embodiment is constituted as described above. Next, the operation of the navigation apparatus 10 will be explained, in particular, the process of determining a plurality of destinations and visiting orders thereof.

Where the current position is output from the current position detecting unit 11 and a destination is also determined, for example, according to an input operation of the input operating unit 14 by an operator, the navigation processing unit 42 allows the display screen 51a of the display device 51 of the output unit 16 to display a command menu 61 of predetermined processing items (such as “Map,” “List,” “Edit” and “Done”) as shown in (A) of FIG. 5. The navigation processing unit 42 allows it to display an image 62 showing a visiting order of each destination (for example, an image of numbers or that of a double circle indicating a final destination) and names 63 of individual destinations (for example, “Destination-1,” “Destination-2” or the like).

For example, on the display screen 51 a shown in (A) of FIG. 5, a command menu 61 (“List”) is highlighted, which instructs to sort and display a list of all destinations according to the visiting orders. A list of names 63 of all destinations is displayed according to the visiting orders, together with the image 62 displaying a visiting order of each destination. Then, the operator can select other command menus 61 (for example, “Map,” “Edit” or “Done”) by an input operation of the input operating unit 14.

Then, when the command menu 61 (“Edit”) is selected by an input operation of an operator using the input operating unit 14, a list of names 63 of all destinations, sorted by the visiting order, is displayed, together with the image 62 indicating the visiting order of each destination. The operator can add a new destination, and change the visiting order of the destinations. Then, after completion of addition of a destination and change in visiting order of the destination, the command menu 61 (“List”) is again highlighted, and the list of names 63 of all destinations is sorted according to the visiting order, and displayed, together with the image 62 displaying the visiting order of each destination.

Further, the command menu 61 (“Map”) which instructs display of a single map image 64 (map image) for displaying the positions of all destinations on the display screen 51 a is selected according to an input operation of the input operating unit 14 by an operator. In this instance, for example, as shown in (B) of FIG. 5, the single map image 64 for displaying the positions of all destinations is displayed on the display screen 51 a, together with the command menu 61 (“Return”) for instructing a return to a state which displays a list of names 63 of all destinations. The image 62 for displaying the visiting order of each destination (for example, an image of numbers or that of a double circle indicating a final destination) is displayed at a position of each destination on the map image 64.

Further, the operator can select the command menu 61 (“Done”), using an input operation of the input operating unit 14, and instruct the process to quit the addition of a new destination and change in visiting order of the destination. At this time, the process also executes a route search according to a visiting order. Thus, the process executes a calculation for the route search according to the visiting orders of all the destinations determined at this point of time. For example, as shown in (C) of FIG. 5, a map image 66 indicating the route 65 calculated by the calculation is displayed on the display screen 51a, together with the command menus 61 (“Menu” or “Map”). Those command menus instructs the process to switch to other menus or other displaying states of the map.

It is noted that, for example, the map image 66 shown in (C) of FIG. 5 is provided with an enlarged image at an appropriate region.

Hereinafter, a series of processes are explained in which a plurality of destinations and the visiting orders thereof are determined.

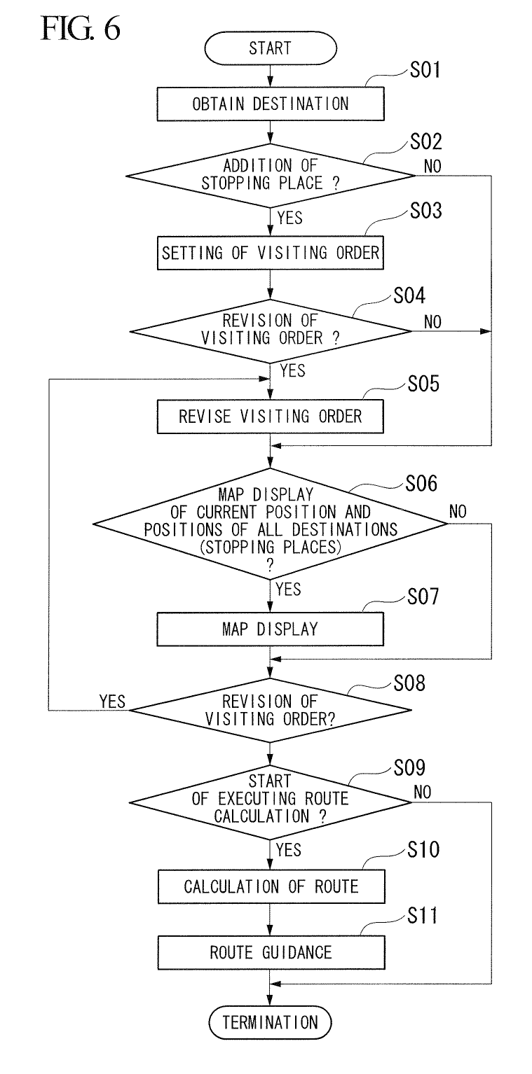

First, in Step S01 shown in FIG. 6, a destination is obtained from the operator through an operation of the input operating unit 14.

Then, in Step S02, a determination is made as to whether or not the destination obtained in Step S01 is a new addition of a stopping place to the list of destinations which has been obtained before execution of the above-described Step S01.

Where the determination result is “NO,” the process proceeds to Step S06 which will be described later.

On the other hand, where the determination result is “YES,” the process proceeds to Step S03.

Then, in Step S03, a list of all destinations is displayed on the display screen 51a, and the visiting orders for all the destinations is determined, for example, by input operations of the operator through the input operating unit 14.

Further, in Step S04, a determination is made as to whether or not any instructions are made for changing (revising) the visiting order.

Where the determination result is “NO,” the process proceeds to Step S06 which will be described later.

On the other hand, where the determination result is “YES,” the process proceeds to Step S05.

Then, in Step S05, the visiting orders for all destinations are revised by the operator, for example, through input operations of the input operating unit 14.

Further, in Step S06, a determination is made as to whether or not an instruction is made for displaying on a single map image the current position and all the destinations made up of stopping places and a final destination.

Where the determination result is “NO,” the process proceeds to Step S08 which will be described later.

On the other hand, where the determination result is “YES,” the process proceeds to Step S07.

Further, in Step S07, the current position and all the destinations are displayed on the single map image.

Then, a determination is made as to whether or not any instructions are made for changing (revising) a visiting order in Step S08.

Where the determination result is “NO,” the process proceeds to Step S09.

On the other hand, where the determination result is “YES,” the process returns to the above-described Step S05.

Further, in Step S09, a determination is made as to whether or not instructions are made for starting the calculation of route search according to visiting orders for all destinations.

Where the determination result is “NO,” the series of process is terminated.

On the other hand, where the determination result is “YES,” the process proceeds to the above-described Step 10.

Then, in Step 10, calculation is executed for a route search according to visiting orders for all the destinations determined at this point of time.

Further, in Step S11, route guidance is executed according to the thus searched route, thereby terminating the series of processes.

As described above, according to the navigation apparatus 10 of the present embodiment, where visiting orders of a plurality of destinations (stopping places) are determined or changed, the current position and positions of all destinations are displayed on a single map image 64. Therefore, an operator is allowed to recognize an actual road and also grasp a route which can be selected. Even where operations such as addition/deletion of a destination and change in visiting order are repeatedly executed, it is possible to improve the convenience.

Further, where visiting orders of a plurality of stopping places are determined or revised, the current position and positions of all destinations are displayed on the single map image 64 at the timing before calculation of a route. Therefore, it is possible to prevent the calculation of unnecessary routes by the processing of a route search before determination of a destination and the visiting order thereof. Even where operations such as addition/deletion of a destination and change in visiting order are executed repeatedly, it is possible to prevent the excessive lengthening of time required for determining a destination and the visiting order thereof.

Further, when the current position and positions of all destinations are displayed on the single map image 64, a number according to a visiting order is given with respect to a destination. Therefore, it is possible to further improve the convenience of the operation.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A navigation apparatus comprising:
an input operating unit which receives instructions of a user;
a map image storage member which stores a map image;
a display member capable of displaying the map image;
a current position detecting member which detects the current position of a user;
a destination determination member which determines a plurality of destinations;
a visiting order determination member which determines a visiting order of each of the plurality of destinations in an revisable manner;
a display control member which displays on the display member the map image on which the current position of the user and positions of all of the plurality of destinations are displayed; and
a route calculation member which calculates a route from the current position by way of all of the plurality of destinations according to the visiting orders.

2. The navigation apparatus according to claim 1, wherein the route calculation member starts the calculation of the route after displaying the map image on which the current position of the user and the positions of all of the plurality of destinations are displayed.

3. The navigation apparatus according to claim 1, wherein the route calculation member starts the calculation of the route after a user instruction to execute the calculation through the input operating unit.

4. The navigation apparatus according to claim 1, wherein the display control member displays the visiting orders corresponding to each of the destinations on the map image.

5. A navigation method comprising:
displaying a map image on a display member;
detecting the current position of a user;
obtaining a plurality of destinations;
determining or revising visiting orders of each of the plurality of destinations;
displaying on the display member the map image on which the current position and positions of all the destinations; and
calculating a route connecting the current position and all the destinations according to the visiting orders.

6. The navigation method according to claim 5, wherein calculating the route starts is performed after displaying the destinations.

7. The navigation method according to claim 5, wherein calculating the route starts is performed after an instruction of the user to perform the calculation.

8. The navigation method according to claim 5, wherein when displaying the destinations on the map image, the visiting order corresponding to each of the destinations is displayed.
